(19) United States
(12) Patent Application Publication
(10) Pub. No.: US 2010/0230192 A1
(43) Pub. Date: Sep. 16, 2010

(54) Hybrid vehicle

(76) Inventor: Robert Q. Riley, Glendale, AZ (US)

Correspondence Address: MCDONALD HOPKINS LLC, 600 Superior Avenue, East, Suite 2100, CLEVELAND, OH, 44114-2653, US

(21) Appl. No.: 12/381,471

(22) Filed: Mar. 12, 2009

(51) Int. Cl. B60K 6/48; B60W 20/00; B60W 10/06

(52) U.S. Cl. 180/65.25; 180/65.28

(57) ABSTRACT

A hybrid vehicle having a parallel power train configuration and a modular chassis is provided. They hybrid vehicle includes two separate power trains configured to operate independent of one another without any interface or communication, such as a transmission or electrical sensors, between them. The hybrid vehicle chassis includes a pair of subassemblies interconnected by a tunnel frame to form an integral structural frame. A combustion engine, suspension, and steering system are contained within the first subassembly. An electric power train and rear suspension are contained within the second subassembly.

### RELATED APPLICATIONS

This non-provisional application claims the benefit of U.S. Provisional Patent Application No. 61/035,664 entitled A PARALLEL HYBRID VEHICLE WITH THREE-WHEEL RECONFIGURABLE CHASSIS AND POWER SYSTEM, AND SIMPLIFIED CONTROLS WITH NO IN-VEHICLE POWER TRANSMISSION BETWEEN ELECTRIC AND COMBUSTION POWER SYSTEMS“filed Mar. 11, 2008, which is hereby incorporated by reference in its entirety.

### FIELD OF THE INVENTION

The present invention is generally related to an improved hybrid vehicle.

### BACKGROUND OF THE INVENTION

In recent years, increased worldwide power consumption has exposed the reality that fossil fuels such as coal and oil are depleting at a rapid rate, and someday will be unavailable. In response to this global change, various forms of hybrid vehicles have been designed to help reduce the amount of fuel used by automobiles. While many of these hybrid designs succeed at reducing fuel consumption, they also suffer from various deficiencies.

One common hybrid design is a parallel hybrid that combines a combustion engine with an electric power system. Often, the combustion engine and electric power system are configured to provide power directly to the vehicle's drive train, either in unison or independently. However, this requires a complex transmission, such as a continuously variable transmission, to provide a smooth and variable interface between the two power systems. In addition, parallel hybrids often utilize a complex array of sensors and computer controls to integrate the combustion power and electric power and adjust the systems to varying operating conditions, such as speed, power demand, driver inputs, and battery state-of-charge. The transmission and sensors increase development and manufacturing costs while consuming system power and decreasing the efficiency of the vehicle.

An alternative variation of the parallel hybrid, often called a mild hybrid, utilizes an electric motor connected to the combustion engine flywheel to provide torque assist. In some versions of a mild hybrid, a motor is attached via a transmission to the combustion engine output shaft where it provides essentially the same function, torque assist delivered to the engine. However, mild hybrids provide only a minimal advantage in fuel economy over a true parallel hybrid. Further, because the electric power system is configured to deliver torque-assist to the engine, the vehicle cannot run on electric power alone. Accordingly, there is a need in the art for an improved hybrid vehicle.

### SUMMARY

A hybrid vehicle with a parallel power train configuration is provided. The hybrid vehicle includes a modular chassis having a pair of subassemblies connected by a tunnel frame. The first subassembly may support a combustion engine and the second subassembly may support an electric power train. The combustion engine and electric power train are configured to operate independent of one another without any interface, such as a transmission or electrical sensors, to communicate between them.

The first and second subassemblies may connect to the tunnel frame to form an integral structural frame, capable of supporting and driving the hybrid vehicle. The combustion engine and electric power train, and all related components, may be completely contained within their respective subassemblies. The front and rear suspensions, as well as the steering system and other drive systems may also be contained within the respective subassemblies.

### DESCRIPTION OF THE DRAWINGS

Reference to the detailed description is taken in connection with the following illustrations:

FIG. 1 illustrates a perspective view of a hybrid vehicle chassis;

FIG. 2 illustrates a top view of a hybrid vehicle chassis;

FIG. 3 illustrates a side view of a hybrid vehicle chassis;

FIG. 4 illustrates an isometric exploded view of a hybrid vehicle chassis;

FIG. 5 illustrates a front view of a first subassembly;

FIG. 6 illustrates a front isometric view of a first subassembly;

FIG. 7 illustrates a rear isometric view of a first subassembly;

FIG. 8 illustrates a top view of a first subassembly;

FIG. 9 illustrates a top view of a second subassembly;

FIG. 10 illustrates a front isometric view of a second subassembly;

FIG. 11 illustrates a side view of a second subassembly;

FIG. 12 illustrates a rear isometric view of a second subassembly;

FIG. 13 illustrates an exploded view of a second subassembly;

FIG. 14 illustrates a magnified exploded view of a second subassembly;

FIG. 15 illustrates a flow diagram for a combustion engine mode;

FIG. 16 illustrates a flow diagram for an electric mode;

FIG. 17 illustrates a flow diagram for a hybrid mode;

FIG. 18 illustrates a side view of a throttle integrator in electric mode;

FIG. 19. illustrates a perspective view of a throttle integrator in electric mode;

FIG. 20 illustrates a side view of a throttle integrator in hybrid or combustion mode;

FIG. 21 illustrates a perspective view of a throttle integrator in hybrid or combustion mode;

FIG. 22 illustrate a steering wheel assembly in drive position;

FIG. 23 illustrates a steering wheel assembly in ingress/egress position.

### DETAILED DESCRIPTION OF PREFERRED EMBODIMENTS

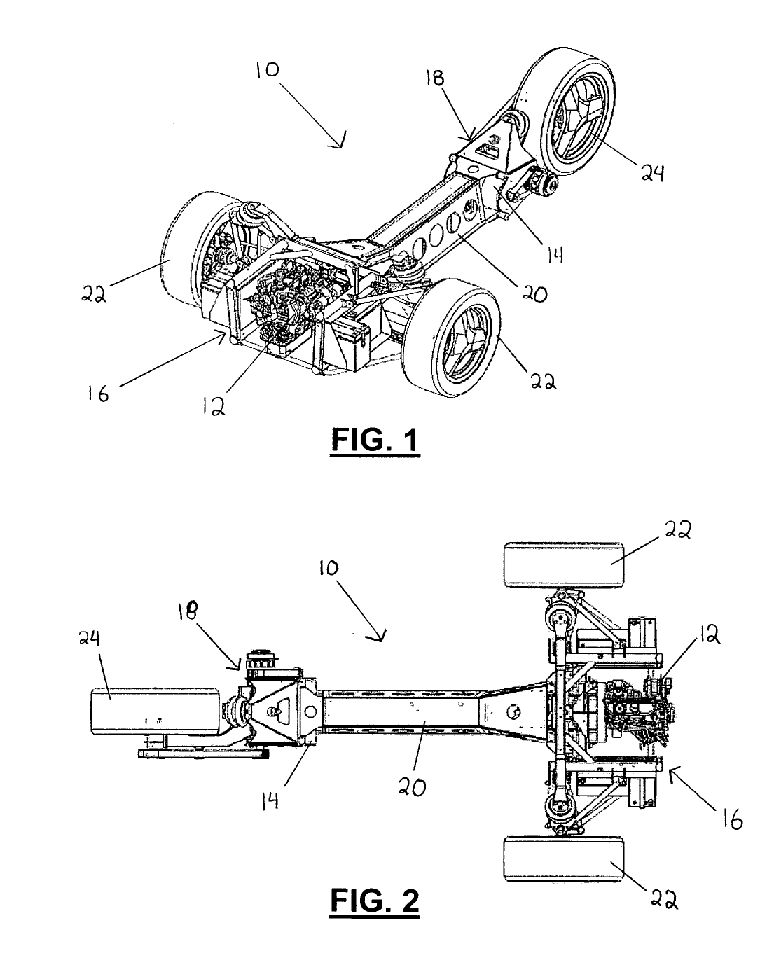

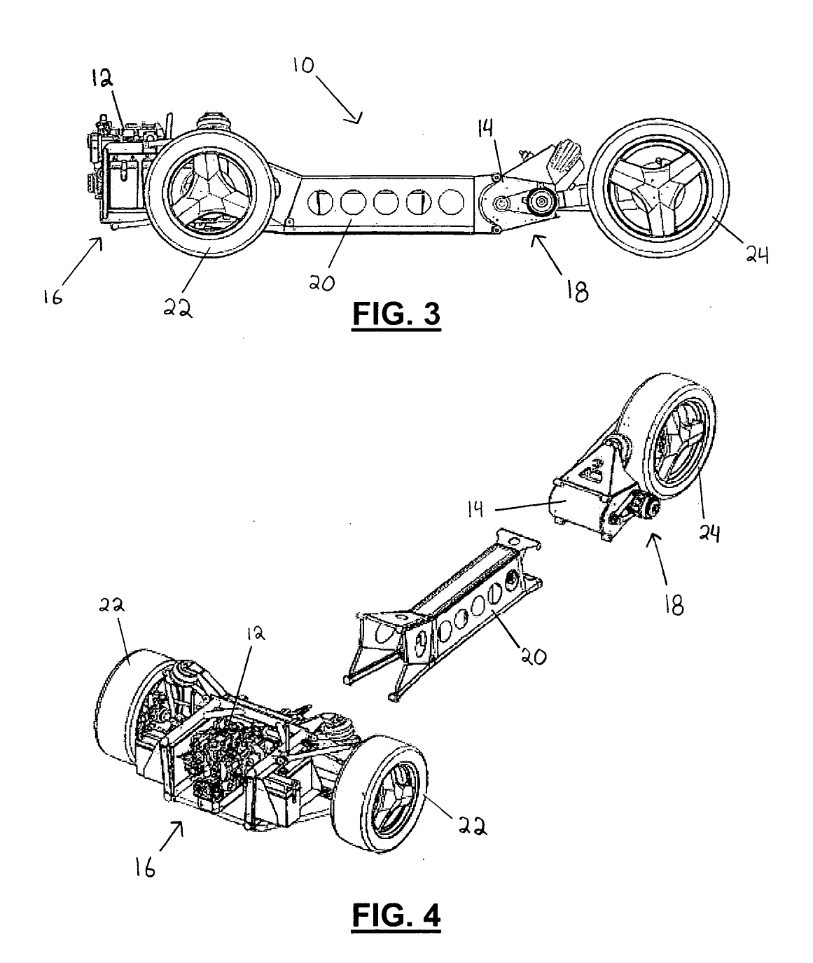

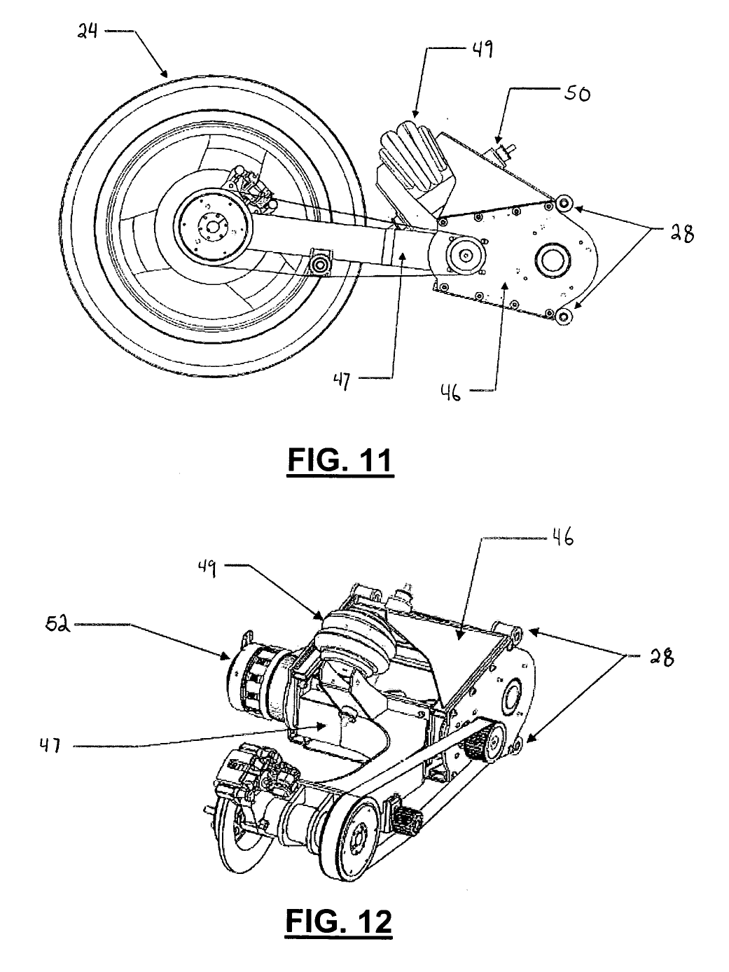

As generally illustrated in FIGS. 1-14, a chassis 10 for a hybrid vehicle is provided. The chassis 10 is configured to minimize the mass of the hybrid vehicle, thereby reducing manufacturing costs and power consumption. The chassis 10 includes a parallel power system having two separate power trains 12, 14. For example, the hybrid vehicle may include a combustion engine 12 and an electric power train 14. The electric power train 14 may further comprise an electric motor coupled to an electric power source, such as a battery. However, it will be appreciated that the hybrid vehicle may include any combination of combustion, electric, and any other power sources known in the art.

The chassis 10 is configured to support the power trains 12, 14 so as to drive the hybrid vehicle. As illustrated in FIGS. 1-4, the chassis 10 comprises a first subassembly 16 and second subassembly 18 interconnected by a tunnel frame 20. The subassemblies 16, 18 and tunnel frame 20 may connect together to form the integral structural frame of the chassis 10. While the subassemblies 16, 18 and tunnel frame may be unable to support the hybrid vehicle individually, when combined the subassemblies 16, 18 and tunnel frame 20 form an integral structural frame capable of supporting and driving the hybrid vehicle.

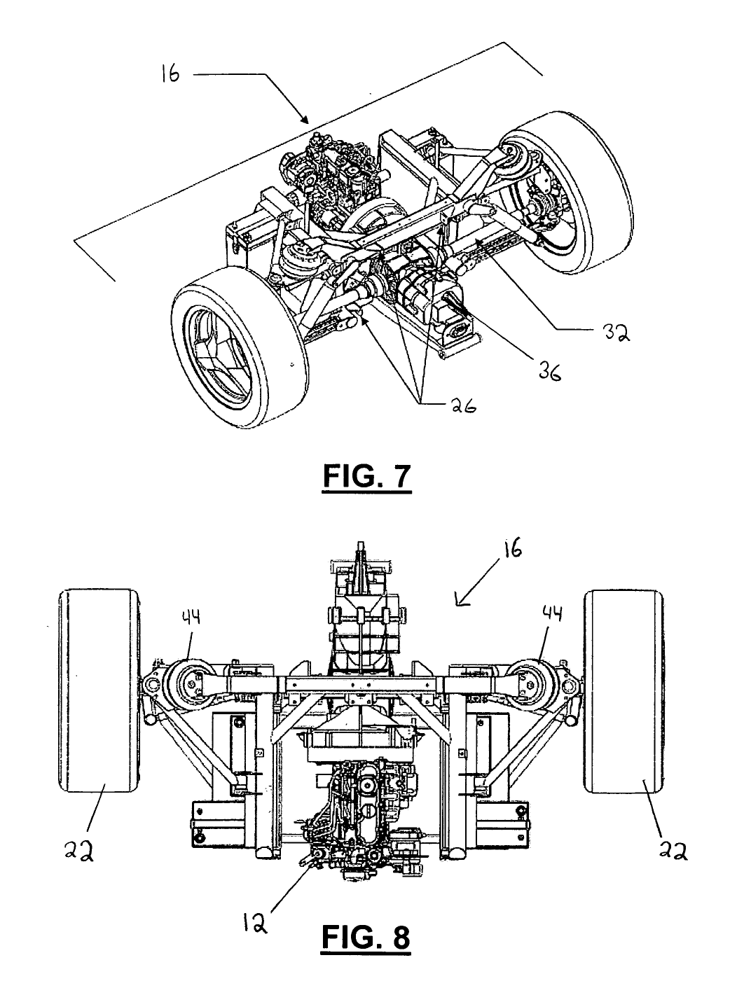

As best illustrated in FIGS. 7 and 10, each subassembly 16, 18 includes a plurality of attachment points 26, 28 for connecting to the tunnel frame 20. The subassemblies 16, 18 may be removably connected to the tunnel frame 20, thereby allowing them to be removed and replaced without affecting the rest of the chassis 10. In an embodiment, the first and second subassemblies 16, 18 may be bolted to an end of the tunnel frame. However, it will be appreciated that the subassemblies may be connected to the tunnel frame 20 by any means known in the art.

The power trains 12, 14 may be each contained within their respective subassemblies 16, 18. The first subassembly may contain all components of the combustion engine necessary to drive the hybrid vehicle, while the second subassembly 18 may contain all components of the electric power train 14 necessary to drive the hybrid vehicle. Other components of the hybrid vehicle may also be contained within each subassembly 16, 18. It will be appreciated that the first subassembly 16 containing the combustion power train 12 may be either the front or rear subassembly, and the second subassembly 18 containing the electric power train 14 may be arranged at the end of the tunnel frame 20 opposite to the first subassembly 16.

The hybrid vehicle includes a plurality of wheels 22, 24 to support the chassis 10. The wheels may be connected to each subassembly 16, 18 and driven by the corresponding power train 12, 14. In an embodiment, the hybrid vehicle includes three wheels. A pair of wheels 22 are connected to the first subassembly 16 and a single wheel 24 is connected to the second subassembly 18. Alternatively, the first subassembly 16 may include a single wheel 24 and the second subassembly may include a pair of wheels 22. However, though the hybrid vehicle is illustrated and described as having three wheels, it will be appreciated that he hybrid vehicle may include any number of wheels.

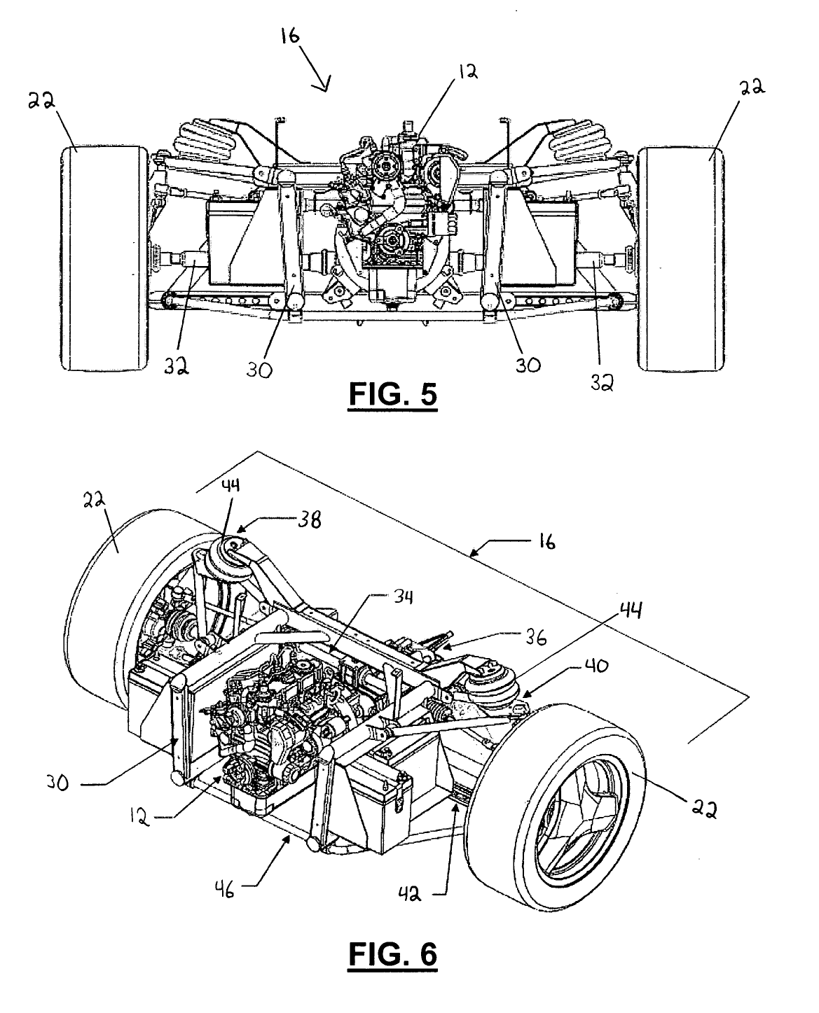

With reference to FIGS. 5-8, the first subassembly 16 may include a frame 30 to support the combustion engine 12 and other subassembly components. As previously described, the frame 30 may include attachment points 26 for connecting to the tunnel frame 20. The frame 30 may support a transmission 36 connected to the combustion engine 12 to provide a gear reduction from the combustion engine to the wheels 22. A pair of wheel axles 32 may interconnect the transmission 36 and the wheels 22. The frame 30 further supports a steering assembly 34 to steer the wheels 22. The steering assembly 34 may be a rack and pinion steering assembly, or any other steering assembly known in the art.

The first subassembly 16 may further include a first suspension assembly 38 to decrease and absorb the noise, harshness and vibration that impacts the hybrid vehicle. The first suspension assembly 38, and all components related to the first suspension assembly 38, may be contained within the first subassembly 16. The first suspension assembly 38 comprises an upper control arm 40 and a lower control arm 42 to interconnect the frame 30 and the wheels 22. A spring component 44, such as an air spring, is connected between the first suspension assembly 38 and the frame 30 to dampen impact absorbed by the wheels 22 and the frame 30. It will be appreciated that the spring component 44 is not limited to an air spring, and may be any suspension components, such as a shock, strut, or any other suspension component known in the art. The first suspension assembly 38 may further include an anti roll bar 46 to increase the stiffness of the first suspension assembly 38.

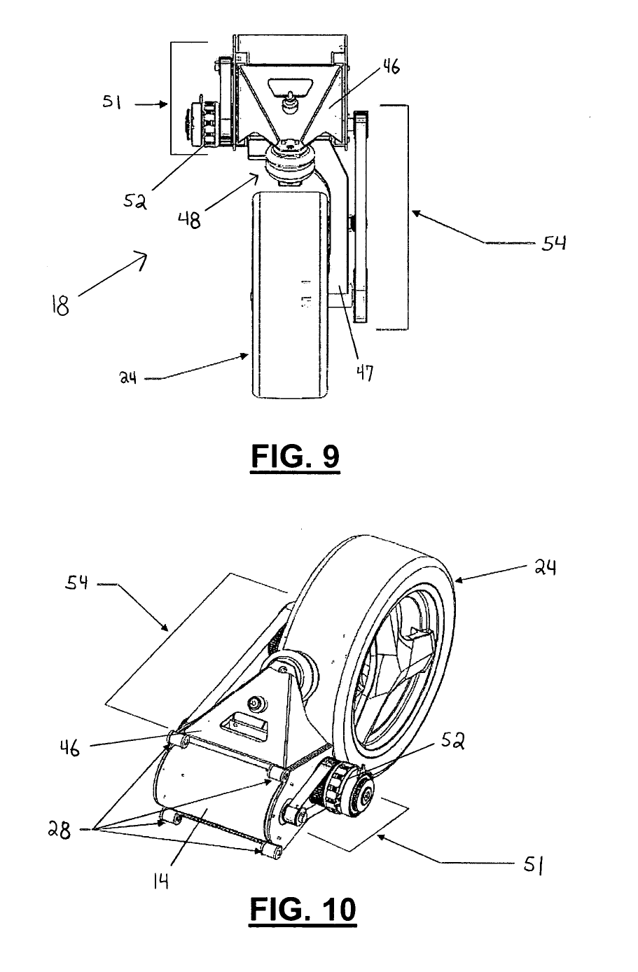

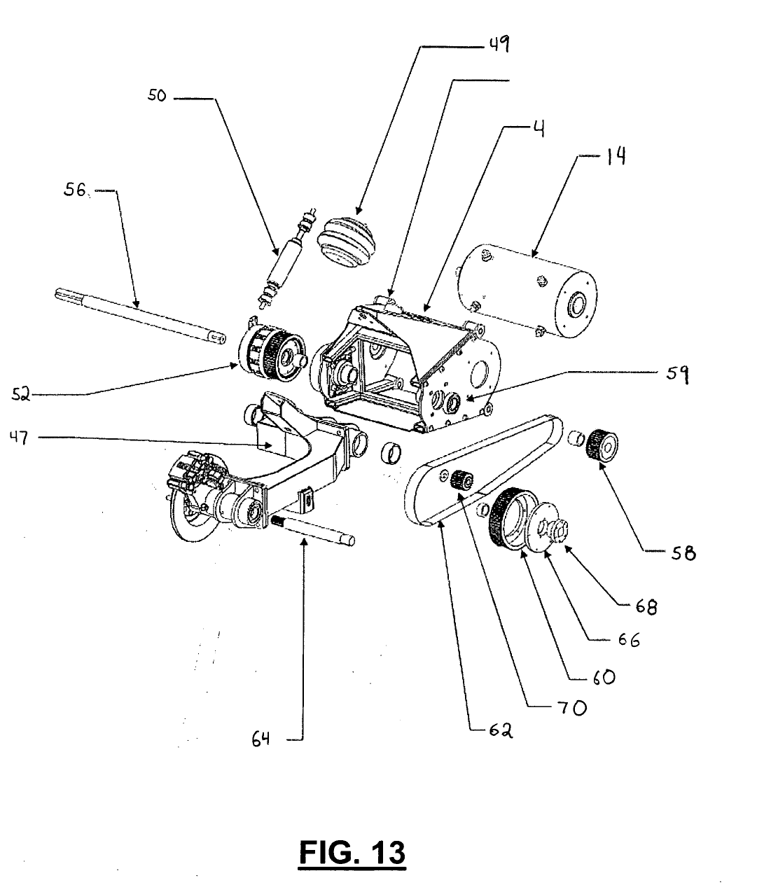

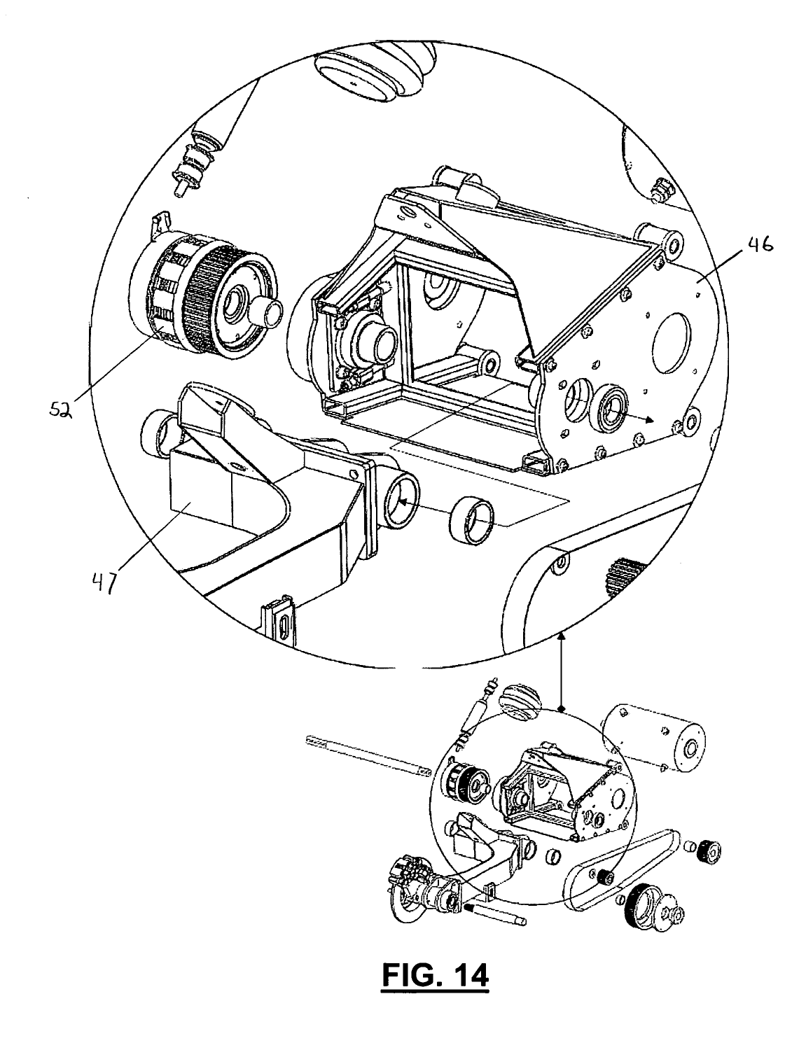

With reference to FIGS. 9-14, the second subassembly 18 may include a housing 46 to support the electric power train 14 and a rear suspension 48. The housing 46 may connect to the tunnel frame 20 at attachment points 28 located on the housing 46. The second subassembly 18 may further include a trailing arm 47 connected to the housing 46 to support the rear wheel 24. In an embodiment, the trailing arm 47 is pivotally connected to the housing 46. As illustrated in FIG. 14, a cylindrical portion of the trailing arm 47 rotatably engages an aperture in the housing 46. The rear suspension 48 and all related components may be contained within the second subassembly 18. Specifically, the rear suspension 48 may be arranged between the housing 46 and the trailing arm 47 to dampen and resist forces that impact the rear wheel 24. The rear suspension 48 may include conventional suspension components such as an air spring 49 or a shock absorber 50. (FIG. 13.)

A clutch 52 may be connected to the electric power train 12 to selectively engage and drive the rear wheel 24. (FIGS. 9 and 10.) The clutch 52 may connect directly to a pulley of a belt assembly 51 driven by the shaft of the electric power train 12. When the clutch 52 is engaged, power is transferred from the electric power train 14 to the rear wheel 24. When the clutch 52 is disengaged, the rear wheel 24 is allowed to rotate freely.

In an embodiment, the electric power train 12 drives the rear wheel 24 by way of a secondary belt assembly 54. (FIG. 10.) A lay shaft 56 interconnects the clutch 52 and the secondary belt assembly 54. (FIGS. 10 and 13.) More specifically, the clutch 52 receives the first end of the lay shaft 56 while the second end of the lay shaft 56 engages a driver pulley 58 of the secondary belt assembly 54. (FIG. 13.) A bearing 59 may be inserted between the lay shaft 56 and the driver pulley 58 to decrease friction. The driver pulley 58 drives a secondary pulley 60 via a belt 62. The secondary pulley 60 engages a rear wheel axle 64 to drive the rear wheel 24. A mounting plate 66 and bushing 68 may be mounted to the rear pulley 60 to receive the rear wheel axle 64. The secondary belt assembly 54 may further include a tension adjustment idler 70 to adjust the tension of the belt 62.

In operation, the electric power train 14 drives the clutch 52 via the belt assembly 51. (FIG. 10.) The clutch 52 engages the lay shaft 56 to transfer power to the secondary belt assembly 54, which in turn drives the rear wheel 24. When the clutch 52 disengages the lay shaft 56, the rear wheel 24, secondary belt assembly 54, and lay shaft 56 are able to rotate freely.

The combustion engine 12 and electric power train 14 may operate independent of one another. For example, unlike traditional parallel hybrids that include a mechanical interface, such as a transmission, or electrical interfaces, such as sensors, between the electric and combustion power trains, the combustion engine 12 and the electric power train 14 may power the hybrid vehicle without any electrical or mechanical communication within the chassis 10. When the hybrid vehicle is driven along a surface, the surface may provide a mechanical link between the front wheels 22 and the rear wheel 24, thereby providing some communication between the power trains 12, 14. However, the hybrid vehicle may require no mechanical or electrical interface within the chassis 10 between the combustion engine 12 and the electric power train 14.

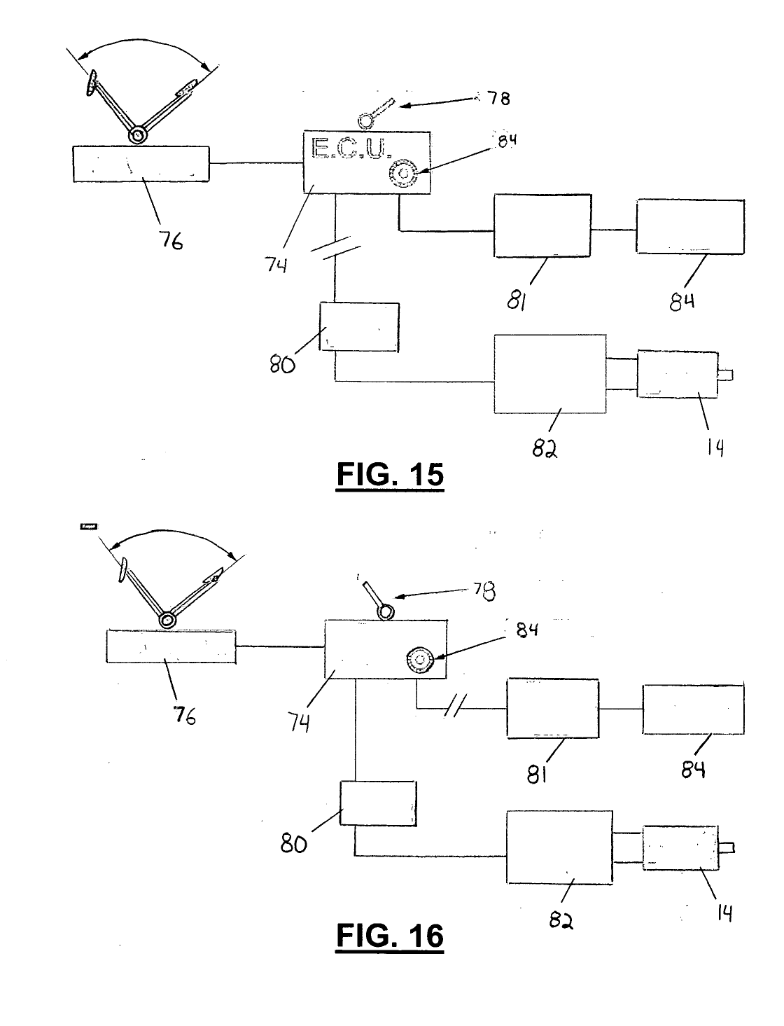

The chassis 10 may be configured to operate in different power modes. For example, the hybrid vehicle may include an electric power train mode, a combustion engine 12 mode, and a hybrid mode. FIGS. 15-17 illustrate flow diagrams of the various power modes. A control unit 74 may selectively route an input signal from a pedal 76 to the combustion engine, the electric power train, or both. The power modes may be driver selectable. For example, the control unit 74 may include a selector switch 78 such as a three position switch, or other switching means to allow an operator to select the desired power mode.

FIG. 15 illustrates a flow diagram for the hybrid vehicle in combustion engine mode, wherein the chassis 10 is powered exclusively by the combustion engine 12. The interface between the pedal 76 and the electric power train 14 is bypassed electrically, mechanically, or electromechanically to turn off the electric power train 14 and conserve electric power. The clutch 52 is disengaged to allow the rear wheel 24 to rotate freely. In this mode, the control unit 74 routes the pedal 76 input to a throttle control 81. Depression of the pedal 76 sends a signal to the throttle control 81, to operate the throttle 84 of the of the combustion engine 12 in a conventional manner.

FIG. 16 illustrates a flow diagram for the hybrid vehicle in electric mode, wherein the chassis 10 is powered exclusively by the electric power train 14. As shown, the combustion engine 12 circuit is disconnected from the pedal 76 either electrically, mechanically, or electromechanically. The control unit 74 routes the input signal from the pedal 76 to an electronic power controller 80. The electronic power controller 80 controls power the electric power train 14 via a chopper controller 82 in a conventional manner. (FIG. 16.)

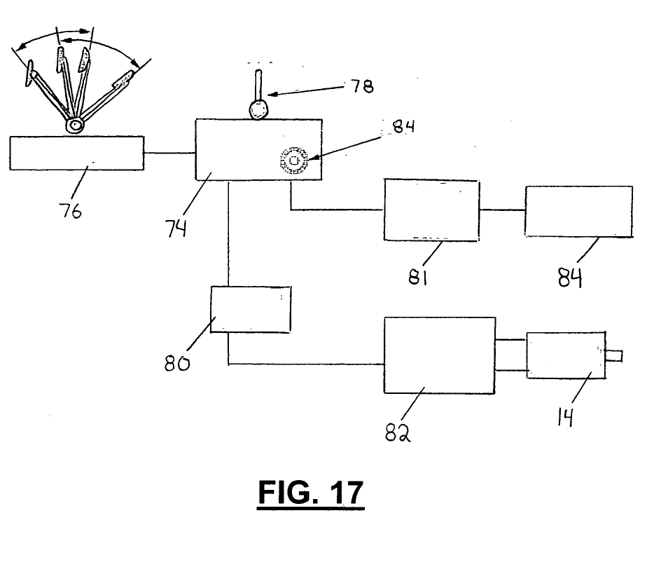

As shown in FIG. 17, the control unit 74 may be set in hybrid mode, wherein the chassis 10 is powered by both the combustion engine 12 and the electric power train 14. In hybrid mode, the ratio of power supplied to the chassis 10 by the combustion engine 12 and the electric power train 14 varies based on how far the pedal 76 is depressed. When the pedal 76 is first depressed, the combustion engine 12 provides power to the front wheels 22, while the electric power train 14 remains in an idle state. At this stage, depression of the pedal 76 controls power output of the combustion engine 12 in a conventional manner. Once the pedal 76 is depressed to a first predetermined point, the electric power train 14 begins to supplement power to the rear wheel 24. When the pedal 76 is further depressed to a second predetermined point, the combustion engine 12 reaches full throttle where it remains throughout the remainder of pedal travel. At full pedal depression, both the combustion engine 12 and the electric power train 14 are at full power. The predetermined points at which power from the electric power train 14 is introduced may be adjusted. For example, the control unit 74 may include an adjust knob 82 to adjusts the amount of pedal-travel-overlap between the power trains 12, 14.

As described above, the electric power train 14 serves as an acceleration enhancer in hybrid mode, but not as the primary source of power. Therefore, the hybrid vehicle may operate in hybrid mode with minimal contribution from the electric power train 14, depending on the driving habits of the operator. However, regardless of operator habits, hybrid mode conserves electric energy and provides added acceleration power when needed.

By utilizing the electric power train 14 as an acceleration enhancer in hybrid mode, the hybrid vehicle requires a less power from the combustion engine 12. In many automobiles, large engines that cause poor fuel economy only use full power during peak acceleration, and run at a reduced load at all other times. The acceleration assist provided by the electric power train 14 therefore reduces the size requirements of the combustion engine, thereby improving fuel economy of the hybrid vehicle.

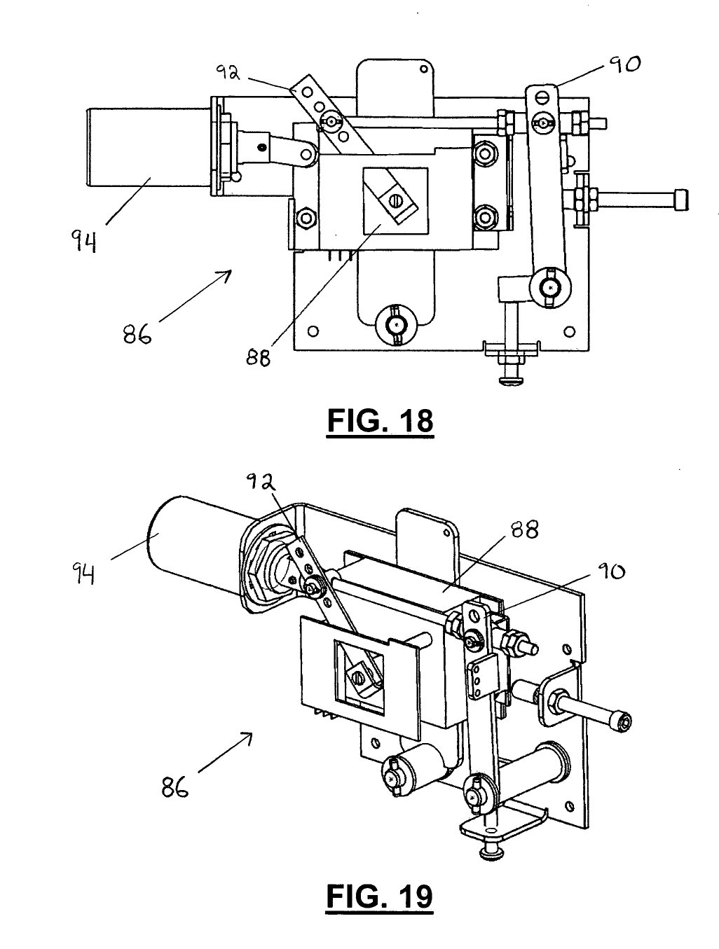

The hybrid vehicle may include a throttle integrator 86, illustrated in FIGS. 18-21, to adjust the interface between the pedal 76 and the power trains 12, 14. The throttle integrator 86 may be an electromechanical device that operates both a conventional throttle for the combustion engine 12 and a potentiometer 88 to regulate the electric power train 14. Specifically, the pedal 76 may be mechanically tied to an integrator lever 90 on the throttle integrator 86. The integrator lever 90 is further connected to both the potentiometer lever 92 and the combustion engine throttle lever (not shown). When the pedal 76 is depressed, the integrator lever 90 pulls on both the potentiometer lever 92 and the combustion engine throttle lever, thereby activating the respective power trains 12, 14.

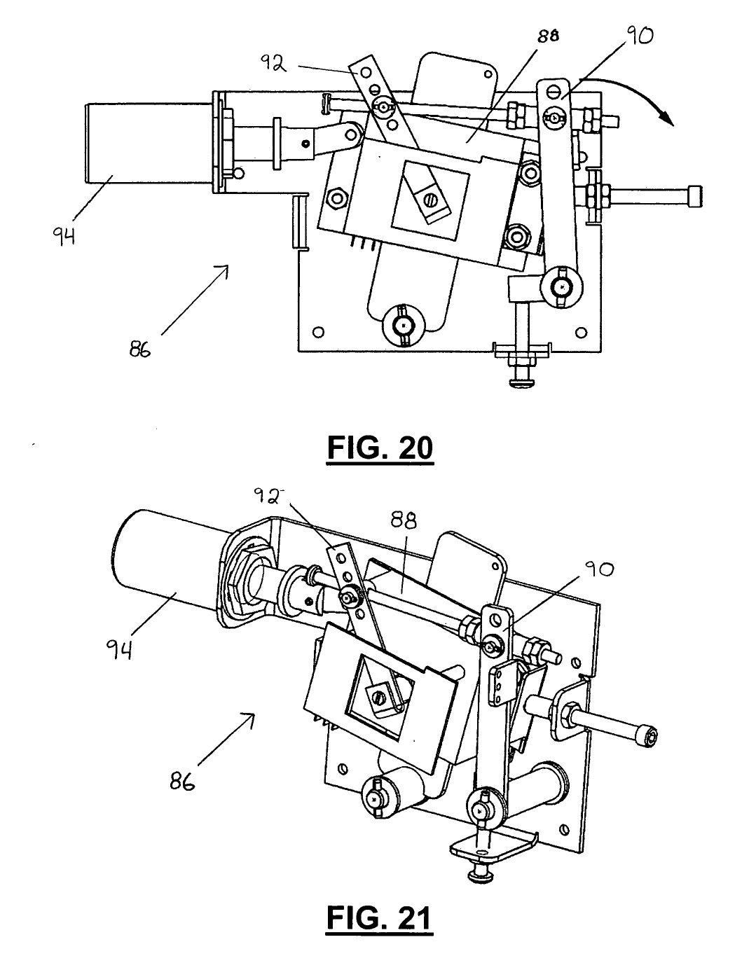

The throttle integrator 86 may control the throttles differently depending on the hybrid vehicle mode. For example, the throttle integrator 86 includes a solenoid 94 to adjust the potentiometer 88 between two positions. In electric mode, shown in FIGS. 18 and 19, the solenoid 94 is retracted to move the potentiometer lever 92 further away from the integrator lever 90. In this position, the potentiometer lever 92 is pulled immediately when the pedal 76 is depressed. In hybrid and combustion modes, as shown in FIGS. 20 and 21, the solenoid 94 is extended, thereby moving the potentiometer lever 92 closer to the integrator lever 90. The decreased distance between the integrator lever 90 and the potentiometer lever 88 creates a delay between depression of the pedal 76 and activation of the potentiometer lever 92.

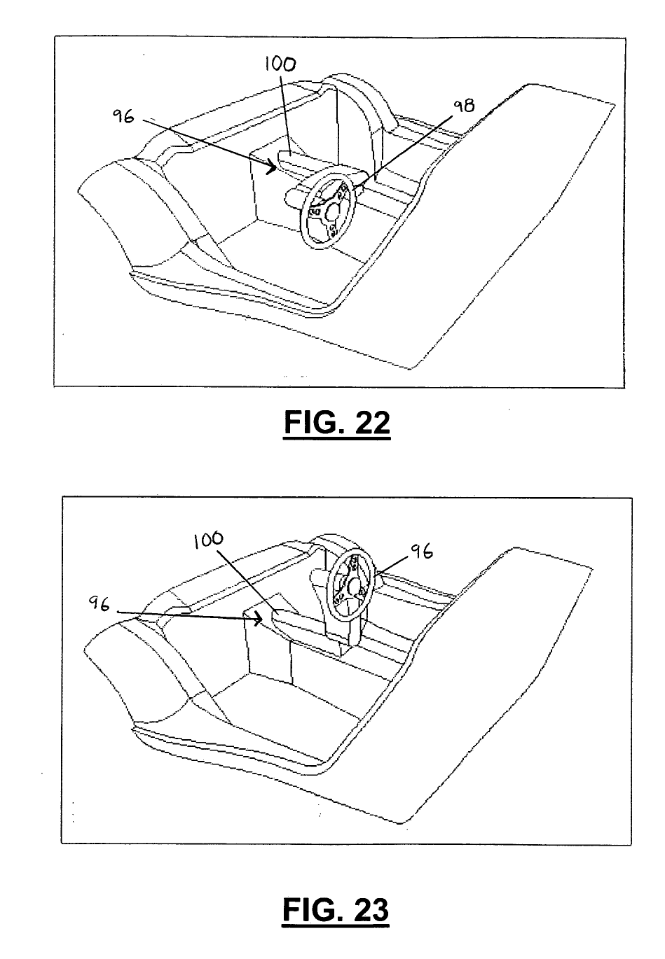

The hybrid vehicle may include an adjustable steering wheel assembly 96. (FIGS. 22 and 23.) The steering wheel 98 may be pivotal between a drive position shown in FIG. 22 and an ingress/egress position shown in FIG. 23. The steering wheel 98 may be locked into position by a locking pin, such as a spring loaded pin. The flexible steering design allows for the steering wheel 98 to be used on either the right or left side of the hybrid vehicle.

The steering wheel assembly 96 may further include a steering column 100 designed to yield in response to a force against the steering wheel 98. For example, the steering wheel assembly 98 may include a joint, located at the base of the steering assembly 96, configured to yield in response to an overloading force. This yielding steering assembly 96 may alleviate the need for an airbag in the hybrid vehicle.

The steering column 100 may further be connected to a rack and pinion steering system (not shown). In an embodiment, the steering column 100 is connected to the rack and pinion steering system by a lateral drive chain (not shown). The lateral drive chain allows the steering column 100 and rack and pinion steering system to be arranged in a non-linear configuration.

The embodiment of the invention has been described above and, obviously, modifications and alternations will occur to others upon reading and understanding this specification. The claims as follows are intended to include all modifications and alterations insofar as they are within the scope of the claims or the equivalent thereof.

What is claimed is:

1. A hybrid vehicle chassis comprising:
a first subassembly including a first power train to drive one or more wheels;
a second subassembly including a second power train to drive one or more wheels;
a frame interconnecting said first subassembly and said second subassembly; and
wherein said first power train and second power train are configured to independently drive the wheels of their respective subassemblies without mechanical or electrical communication within said hybrid vehicle chassis between said first and second power trains.

2. The hybrid vehicle chassis of claim 1, wherein said first power train is a combustion engine.

3. The hybrid vehicle chassis of claim 2, wherein said second power train is an electric power train.

4. The hybrid vehicle chassis of claim 3, wherein two wheels are connected to said first subassembly and driven by said combustion engine.

5. The hybrid vehicle chassis of claim 4, wherein a single wheel is connected to said second subassembly and driven by said electric power train.

6. The hybrid vehicle chassis of claim 5, wherein said first subassembly and said second subassembly are removably connected to said frame.

7. The hybrid vehicle chassis of claim 6 further comprising a suspension system contained within said first subassembly.

8. The hybrid vehicle chassis of claim 7 further comprising a steering system contained within said first subassembly.

9. The hybrid vehicle chassis of claim 8 further comprising a suspension system contained within said second subassembly.

10. A hybrid vehicle chassis comprising:
a frame member;
a first subassembly connected to a first end of said frame member, said subassembly including a first power train to drive two wheels;
a second subassembly connected to a second end of said frame member, said subassembly including a second power train to drive a single wheel; and
wherein said hybrid vehicle chassis may be selectively driven exclusively by said first power train, exclusively by said second power train, or by both said first and said second drive trains in unison.

11. The hybrid vehicle chassis of claim 10, wherein said first power train and second power train are configured to independently drive the wheels of their respective subassemblies without mechanical or electrical communication within said hybrid vehicle chassis between the first and second power train.

12. The hybrid vehicle chassis of claim 11 wherein said first power train is a combustion engine.

13. The hybrid vehicle chassis of claim 12, wherein said second power train is an electric power train.

14. The hybrid vehicle chassis of claim 13, wherein said first subassembly includes a suspension contained within said first subassembly.

15. A hybrid vehicle chassis comprising:
a first subassembly supporting a first power train to drive one or more front wheels;
a second subassembly supporting a second power train to drive one or more rear wheels;
a frame interconnecting said first subassembly and said second subassembly;
wherein said first power train and second power train are configured to independently drive the wheels of their respective subassemblies without mechanical or electrical communication within said hybrid vehicle chassis between the first and second power train; and
wherein said second drive train includes a mechanical clutch to allow said second drive train to selectively engage said rear one or more wheels.

16. The hybrid vehicle chassis of claim 15, wherein two wheels are driven by said first subassembly and a single wheel is driven by said second subassembly.

17. The hybrid vehicle chassis of claim 16, wherein said first power train is a combustion engine.

18. The hybrid vehicle chassis of claim 17, wherein said second power train is and electric power train.

19. The hybrid vehicle chassis of claim 18, wherein said first subassembly and said second subassembly are removably connected to said frame.

20. The hybrid vehicle chassis of claim 19, wherein said first subassembly contains a suspension system and a steering system.
